(19) United States
(12) Patent Application Publication
(10) Pub. No.: US 2003/0117011 A1
(43) Pub. Date: Jun. 26, 2003

(54) Trailer brake control in a tow vehicle

(75) Inventor: Robert J. Ackley, South Lyon, MI (US)

Correspondence Address: DELPHI TECHNOLOGIES, INC., Legal Staff Mail Code: 482-204-450, P.O. BOX 5052, 1450 W. Long Lake, Troy, MI, 48098, US

(73) Assignee: DELPHI TECHNOLOGIES INC.

(21) Appl. No.: 10/042,372

(22) Filed: Dec. 21, 2001

(51) Int. Cl. B60T 13/00

(52) U.S. Cl. 303/7; 303/6.01

(57) ABSTRACT

A trailer braking system for use in vehicles with automated braking systems, such as anti-lock brake systems (ABS) or traction control systems (TCS), integrates the trailer brake controller physically and functionally into the on-board controller for the automated braking system of the tow vehicle.

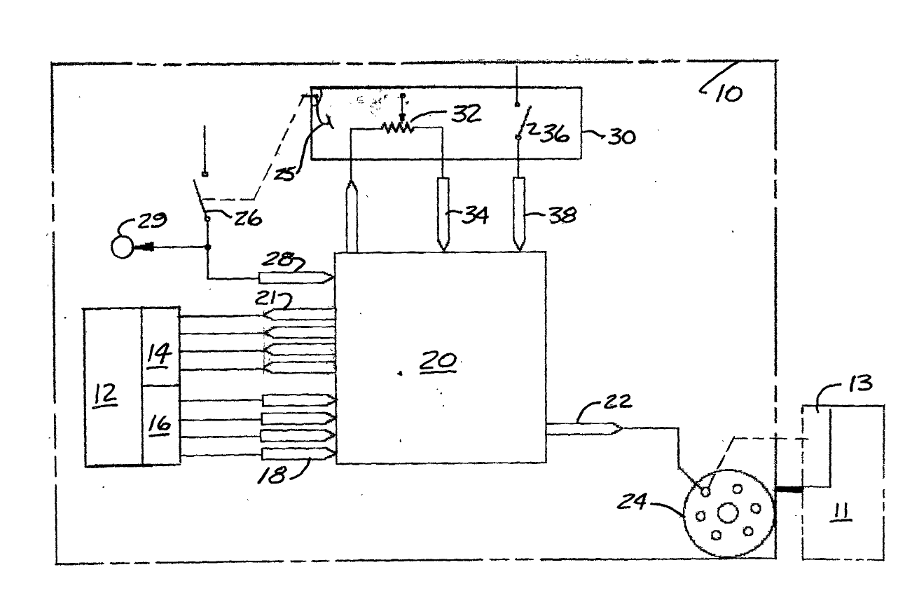

### TECHNICAL FIELD OF THE INVENTION

This invention relates to controlling brakes in trailers being towed by a tow vehicle, and more particularly to controlling brakes in trailers being towed by tow vehicles having on-board anti-lock or traction control brake systems.

### BACKGROUND OF THE INVENTION

In order to maintain control of larger trailers being towed behind a tow vehicle, such as an automobile, a pick-up truck or a motor home, it is necessary that the trailer be equipped with a braking system. A typical trailer brake control system includes brakes on the wheels of the trailer, and a trailer brake controller mounted in the passenger compartment of the tow vehicle for automatically controlling application of the trailer brakes.

The trailer brake controller typically includes a motion sensing device, such as a pendulum switch, for sensing how quickly the tow vehicle is slowing down or accelerating. The controller typically also receives an electrical input from the brake lights of the tow vehicle, indicating that the vehicle operator has applied brakes in the tow vehicle. When the driver of the tow vehicle steps on the brake pedal in the vehicle to slow or stop the tow vehicle, the brake light signal is sensed by the trailer brake controller, indicating that the trailer brakes need to be applied, and the pendulum switch provides an input to the controller indicating how quickly the vehicle is decelerating. The controller determines how much trailer braking is required and automatically sends an appropriate signal to the trailer for applying the brakes, via a wire harness connecting the trailer brake controller to the brakes on the trailer.

Automatic application and control of the trailer brakes, in this manner, by the trailer brake controller frees the driver from the burden of having to separately apply the trailer brakes, and greatly facilitates safe operation of the tow vehicle and trailer during normal and emergency driving maneuvers. A typical trailer brake controller also includes a “Manual Apply Switch,” allowing the driver to over-ride the automatic control functions of the trailer brake control and apply the trailer brakes manually, should it become necessary to do so in an emergency or in response to certain driving conditions, such as slippery road surface, where it may be desirable to apply the trailer brakes without stepping on the vehicle brake pedal to maintain control of the tow vehicle and trailer. The trailer brake controller will typically also include a “Driver Adjustable Output Switch,” that allows the driver to adjust the amount of trailer braking that will be automatically applied by the controller, to match the operating characteristics of a given trailer to the tow vehicle.

Existing trailer brake controllers are generally add-on devices that are mounted inside the passenger compartment of the tow vehicle, within reach of the driver. They are often cumbersome, and difficult to mount in a position that is accessible to the driver without being bumped constantly by the driver's leg or arm while operating the tow vehicle, or while entering or exiting the passenger compartment. For controllers having motion sensors that must be installed in a particular orientation for proper operation, such as pendulum switches, finding a suitable mounting arrangement within the passenger compartment can be particularly difficult.

In addition to the difficulties involved in finding a suitable mounting arrangement for the trailer brake controller in the passenger compartment, existing trailer brake controllers typically have no provisions for sensing and automatically dealing with driving conditions where the wheels of the tow vehicle are slipping and the driver has not and should not step on the brake pedal of the tow vehicle.

What is needed, therefore, is an improved trailer braking system that provides a solution to one or more of the problems described above.

### SUMMARY OF THE INVENTION

My invention provides such an improved trailer braking system for use in vehicles with automated braking systems, such as anti-lock brake systems (ABS) or traction control systems (TCS), by integrating the trailer brake controller physically and functionally into the on-board controller for the automated braking system of the tow vehicle.

In one form of my invention, an automatic brake controller for a vehicle adapted for towing a trailer controls brakes on both the vehicle and the trailer. The automatic brake controller may be adapted for receiving an input indicating application of the brakes of the vehicle and generating an output signal for applying the trailer brakes in response to receipt of the input indicating application of the vehicle brakes. Where the vehicle includes a brake pedal and a brake pedal switch actuated by application of the brake pedal, the input indicating application of the vehicle brakes may be a signal indicating application of the brake pedal. Where the vehicle includes brake lamps, the signal indicating application of the brake pedal may be an electrical signal adapted to illuminate the brake lamps of the vehicle.

The automatic brake controller may be adapted for receiving a signal indicating motion of the vehicle and applying the trailer brakes in response to the input indicating motion of the vehicle. Where the vehicle includes wheel speed sensors for sensing rotation of the wheels and generating a signal indicating wheel speed, the controller may be adapted for receiving signals from the wheel speed sensors as the input indicating motion of vehicle motion.

The brake controller may include provisions for adjusting the automatic application of the trailer brakes, and provisions for manually applying the trailer brakes.

A vehicle adapted for towing a trailer having brakes, according to my invention, may include wheels, brakes for stopping the wheels, wheel speed sensors for sensing the rotational speed of the wheels and providing a signal indicating rotational speed of the wheels, and an automatic brake controller mounted in the vehicle. The controller includes provisions for controlling the brakes of the vehicle and the brakes of the trailer in response to the signal indicating rotational speed of the wheels. Where the vehicle includes driver operated actuator means for applying the vehicle brakes, and brake actuator sensing means for sensing application of the vehicle brakes and providing a signal indicating application of the vehicle brakes, the automatic controller may further include provisions for controlling the brakes of the vehicle and the brakes of the trailer in response to the signal indicating actuation of the brakes.

The automatic controller may be mounted outside of the passenger compartment of the vehicle, and the vehicle may include an adjustable output switch mounted within the passenger compartment for adjusting the output signal generated by the controller for controlling the trailer brakes. A manual apply switch may be provided within the passenger compartment for manually applying the trailer brakes.

My invention may also take the form of a method for operating a vehicle having wheels, and brakes for stopping the wheels, and adapted for towing a trailer having brakes. The method includes controlling the brakes of the vehicle and the brakes of the trailer in response to the signal indicating rotational speed of the wheels of the vehicle. Where the vehicle includes driver operated means for applying the vehicle brakes, and the method may also include sensing application of the vehicle brakes by the driver and controlling the brakes of the vehicle and the brakes of the trailer in response to application of the vehicle brakes. Where the vehicle includes a passenger compartment and an adjustable output switch mounted in the passenger compartment, the method may further include adjusting the automatic application of the trailer brakes with the adjustable output switch mounted within the passenger compartment.

My invention may also take the form of a computer usable medium including a program for generating instructions for controlling the brakes of a trailer and the brakes on the wheels of a vehicle towing the trailer based upon the rotational speed of the wheels of the vehicle towing the trailer.

The foregoing and other features and advantages of the invention are apparent from the following detailed description of exemplary embodiments, read in conjunction with the accompanying drawing. The detailed description and drawing are merely illustrative of the invention rather than limiting, the scope of the invention being defined by the appended claims and equivalents thereof.

### BRIEF DESCRIPTION OF THE DRAWING

The drawing is a schematic representation of an exemplary embodiment of a vehicle adapted for towing a trailer, the vehicle including an automatic controller, according to my invention, for controlling brakes on the vehicle and the trailer.

### DETAILED DESCRIPTION OF THE PRESENTLY PREFERRED EMBODIMENTS

The drawing is a schematic depiction of an exemplary embodiment of a vehicle 10 adapted for towing a trailer 11 having brakes 13. The vehicle 10 includes wheels 12, brakes 14 for stopping the wheels, and wheel speed sensors 16 for sensing the rotational speed of the wheels 12 and providing a signal 18 indicating rotational speed of the wheels 12. The vehicle 10 also includes an automatic brake controller 20 mounted in the vehicle 10, for providing brake control signals 21 to the brakes 14, or valves (not shown) for controlling the pressure of hydraulic brake fluid in a hydraulic brake system for actuating the brakes 14. The controller 20 includes components for controlling the brakes 14 of the vehicle 10 and generating an output control signal 22 supplied to the brakes 13 of the trailer 11 via a trailer control connector 24, in response to the signal 18 indicating rotational speed of the wheels 12.

The vehicle 10 includes driver operated actuator means, in the form of a brake pedal 25, for applying the vehicle brakes 12, and brake actuator sensing means, in the form of a brake pedal switch 26 for sensing application of the vehicle brakes 12 and providing a signal 28 indicating application of the vehicle brakes 14. The signal 28 may be communicated directly from the switch 26 to the controller 20 by wires, as shown in the drawing, or indirectly through devices such as a local area network or an electrical bus, all of which are contemplated within the scope of my invention. The signal may also be used for other purposes, such as illuminating brake lamps 29 of the vehicle 10. The automatic controller 20 further includes components for controlling the brakes 14 of the vehicle 10 and the brakes 13 of the trailer 11 in response to the signal 28 indicating actuation of the vehicle brakes 14.

It is preferred that the automatic controller 20 be mounted outside of a passenger compartment 30. The vehicle 10 includes means for adjusting the automatic application of the trailer brakes 13, in the form of an adjustable output switch 32 mounted within the passenger compartment 30, and providing a signal 34 to the controller 20. The adjustable output switch 32 is used to adjust the magnitude of the output signal 22 to match a given trailer braking system to the controller 20, and to make adjustments for towing the trailer 11 under special road conditions. The vehicle 10 also includes a manual apply switch 36 mounted within the passenger compartment 30, allowing the driver of the vehicle 10 to send a signal 38 to the controller 20 for manually applying the trailer brakes 13. The manual signal 38 can be used to apply the trailer brakes 13 independently from application of the vehicle brakes 14. This may be desirable for using the trailer brakes 13 to hold the trailer 11 in a parked position, or to help control the combined vehicle 10 and trailer 11 under certain driving conditions, such as driving downhill or on slippery surfaces, or in emergency circumstances following a full or partial failure of the vehicle brakes 14.

While the embodiments of my invention disclosed herein are presently considered to be preferred, various changes and modifications can be made without departing from the spirit and scope of the invention. The term “automatic brake controller” is intended to include any type of on-board device used to automatically control the vehicle brakes, such as anti-lock brake systems, or traction control systems. These automatic controllers may include a combination of mechanical, electrical, electronic, hydraulic, or pneumatic devices.

The scope of the invention is indicated in the appended claims. I intend that all changes or modifications within the meaning and range of equivalents are embraced by the claims.

I claim:

1. An automatic brake controller for a vehicle, the controller comprising:
means for controlling brakes of the vehicle; and
means for controlling brakes of a trailer being towed by the vehicle.

2. The automatic brake controller of claim 1 wherein
the controller is adapted for receiving an input indicating application of the brakes of the vehicle and generating an output signal for applying the trailer brakes in response to receipt of the input indicating application of the vehicle brakes.

3. The automatic brake controller of claim 2 wherein;
the vehicle includes a brake pedal and a brake pedal switch actuated by application of the brake pedal; and
the input indicating application of the vehicle brakes is a signal indicating application of the brake pedal.

4. The automatic brake controller of claim 3 wherein the vehicle includes brake lamps and the signal is an electrical signal adapted to illuminate the brake lamps of the vehicle.

5. The automatic brake controller of claim 1 wherein:
the controller is adapted for receiving a signal indicating motion of the vehicle and applying the trailer brakes in response to the input indicating motion of the vehicle.

6. The automatic brake controller of claim 5 wherein:
the vehicle includes wheel speed sensors for sensing rotation of the wheels and generating a signal indicating wheel speed; and
the controller is adapted for receiving signals from the wheel speed sensors as the input indicating motion of vehicle motion.

7. The automatic brake controller of claim 1 further including means for adjusting the automatic application of the trailer brakes.

8. The automatic brake controller of claim 1 further including manual apply switch means for manually applying the trailer brakes.

9. A vehicle adapted for towing a trailer having brakes, the vehicle comprising:
wheels, brakes for stopping the wheels, wheel speed sensors for sensing the rotational speed of the wheels and providing a signal indicating rotational speed of the wheels; and
an automatic brake controller mounted in the vehicle, the controller comprising means for controlling the brakes of the vehicle and the brakes of the trailer in response to the signal indicating rotational speed of the wheels.

10. The vehicle of claim 9 wherein the vehicle includes driver operated actuator means for applying the vehicle brakes, and brake actuator sensing means for sensing application of the vehicle brakes and providing a signal indicating application of the vehicle brakes, and the automatic controller further comprises means for controlling the brakes of the vehicle and the brakes of the trailer in response to the signal indicating actuation of the brakes.

11. The vehicle of claim 9 wherein the vehicle includes a passenger compartment, and the automatic controller is mounted outside of the passenger compartment.

12. The vehicle of claim 11 wherein the means for adjusting the automatic application of the trailer brakes includes an adjustable output switch mounted within the passenger compartment.

13. The vehicle of claim 11 further including manual apply switch means mounted within the passenger compartment for manually applying the trailer brakes.

14. A method for operating a vehicle having wheels, and brakes for stopping the wheels, and adapted for towing a trailer having brakes, the method comprising:
controlling the brakes of the vehicle and the brakes of the trailer in response to the signal indicating rotational speed of the wheels of the vehicle.

15. The method of claim 14 wherein the vehicle includes driver operated means for applying the vehicle brakes, and the method further comprises sensing application of the vehicle brakes by the driver and controlling the brakes of the vehicle and the brakes of the trailer in response to application of the vehicle brakes.

16. The method of claim 14 wherein the vehicle includes a passenger compartment and an adjustable output switch mounted in the passenger compartment, and the method further comprises adjusting the automatic application of the trailer brakes with the adjustable output switch mounted within the passenger compartment.

17. The method of claim 14 further comprising manually applying the trailer brakes.

18. The method of claim 17 wherein the vehicle includes driver operated means for manually applying the trailer brakes and the method further comprises manually applying the trailer brakes.

19. A computer usable medium including a program for generating instructions for controlling brakes of a trailer and the brakes on the wheels of a vehicle towing the trailer, the program comprising:
computer program code that receives a signal indicating rotational speed of the wheels of the vehicle;
computer program code that calculates a control signal for applying the trailer brakes based on the rotational speed of the wheels of the vehicle; and
computer program code that generates the control signal for transmission to the trailer brakes.

20. The program of claim 19 further comprising:
computer program code that receives a signal indicating application of the vehicle brakes by a driver of the vehicle; and
computer program code that calculates the control signal for applying the trailer brakes based on application of the vehicle brakes by the driver.
